(19) United States
(12) Patent Application Publication
(10) Pub. No.: US 2026/0071123 A1
(43) Pub. Date: Mar. 12, 2026

(54) PREPARATION AND APPLICATION METHODS FOR CARBOSILANE BASED POLYMER SOIL CONDITIONER CAPABLE OF ENHANCING STRESS RESISTANCE OF CROPS

(71) Applicant: SHIHEZI UNIVERSITY, Shihezi City (CN)

(72) Inventors: Xudong JING, Shihezi City (CN); Kaiyong WANG, Shihezi City (CN); Hua FAN, Shihezi City (CN); Changlong SHAO, Shihezi City (CN); Yan SUN, Shihezi City (CN); Jiayu WANG, Shihezi City (CN); Abulikemu ZULAYATI, Shihezi City (CN)

(21) Appl. No.: 19/259,595

(22) Filed: Jul. 3, 2025

Related U.S. Application Data
(63) Continuation of application No. PCT/CN2025/073893, filed on Jan. 22, 2025.

(30) Foreign Application Priority Data
Aug. 27, 2024 (CN) 202411181928.4

(51) Int. Cl. C09K 17/50; A01C 23/04; C08G 77/42; C08G 81/02

(52) U.S. Cl. CPC C09K 17/50; A01C 23/042; C08G 77/42; C08G 81/021

(57) ABSTRACT

A preparation and application method for a carbosilane based polymer soil conditioner capable of enhancing stress resistance of crops uses cheap and readily available straw waste, adds various reactants such as methyl-silicone oil, urea, potassium persulfate, potassium thiosulfate, etc., obtains carbon and silicon-based natural polymer materials with functions of water retention and salt absorption through prepolymerization reactions, and prepares a soil conditioner capable of enhancing stress resistance of crops through a series of polymerization reactions with calcium lignosulphonate, polyacrylamide, etc. The conditioner is formed by polymerization of organic silicon, organic polymer water retaining materials and some other components. The conditioner has the function of water and fertilizer retention, and can also prevent physiological drought of crops caused by soil salinization, thereby improving soil structure, enhancing the stress resistance of the crops, promoting crop growth.

### TECHNICAL FIELD

The present invention belongs to the technical field of soil remediation, and particularly relates to preparation and application methods for a carbosilane based polymer soil conditioner capable of enhancing stress resistance of crops.

### BACKGROUND

Farmland with low or moderate yield has not only low content of soil organic nutrients, but also other environmental factors that limit crop production, and is an important factor that hinders the continuous increase of grain yield in China. The total cultivated area of the irrigated area in Xinjiang is about 90 million mu, wherein the salinization cultivated land is about 35 million mu, accounting for 37.7% of the total cultivated area. Soil salinization refers to the phenomenon that the salt in a bottom layer of the soil rises to a surface layer along with water and accumulates in a plough layer of the soil. In a saline soil environment, crops are forced to absorb Na⁺ and Cl⁻, which leads to salt ion toxicity of the crops, causes physiological drought in plants and makes the crops unable to grow or even die. In addition, due to the perennial high temperature and little rainfall in Xinjiang, nearly ⅔ of the land is damaged by drought, which seriously affects the sustainable development of agriculture in Xinjiang. Although the drip irrigation technology under film is promoted in large area in Xinjiang and reduces the influence of drought on crop growth to some extent, this technology cannot fundamentally solve this problem currently. Therefore, a soil conditioner is developed. How to increase the content of soil organic matter, preserve nutrients of soil and retain soil moisture to the greatest extent is a method to fundamentally solve the defects of regional geographical and climatic characteristics. Patent CN107841314A discloses a soil conditioner having core components including organic components such as amino acid and citric acid. The soil conditioner can regulate the pH value of the soil, alleviate soil salinity damage, and achieve the objectives of low cost and high profit. Patent CN103756685A discloses a soil conditioner having main components including humic acid, attapulgite powder, potassium feldspar powder, etc. This conditioner has the effects of adjusting the pH of the soil and activating the nutrient elements in the soil, thereby enhancing the resistance of crops to salt and alkali and achieving a good effect in improving saline alkali soil. Although the above soil conditioner includes organic, inorganic and biological components, the components are merely mixed simply without forming compounds, which reduces the synergy among the components and makes it difficult to exert the long-lasting effect of the material.

In recent years, research scholars have prepared a series of super absorbent materials using straw biomass raw materials. Patent CN202111513908.9 discloses a straw-based water retaining agent and a preparation method therefor. After the straw is preprocessed with a urea and alkaline solution, the etherifying agent propylene oxide is added for the etherification reaction, and catalysts such as formaldehyde are added for the reaction to prepare the water retaining material with water absorption capacity. Although this preparation method uses the cheap straw as the basic material, organic reaction solvents with certain toxicity are added in the preparation process, which is very easy to cause secondary pollution problems. Patent CN201710718420.7 discloses a straw biomass-based water retaining agent and a preparation method therefor. After the straw is processed by yeast fermentation, acrylic acid, ammonium persulfate and N,N-methylene diacrylamide are added and mixed for the reaction to prepare the straw-based material with water absorption capacity. This method requires the reaction to be carried out in a nitrogen-filled environment and is difficult to form large-scale production.

For the prominent problems of continuous soil salinization and quality reduction of the plough layer, the present invention uses cheap and readily available straw waste, adds various reactants such as methyl-silicone oil, urea, potassium persulfate, potassium thiosulfate, etc., obtains carbon and silicon-based natural polymer materials with functions of water retention and salt absorption through prepolymerization reactions, and prepares a soil conditioner capable of enhancing stress resistance of crops through a series of polymerization reactions with calcium lignosulphonate, polyacrylamide, etc. The conditioner is formed by polymerization of organic silicon, organic polymer water retaining materials and some other trace element components. The conditioner has the function of water and fertilizer retention, and can also prevent physiological drought of crops caused by soil salinization, thereby improving soil structure, enhancing the stress resistance of the crops, promoting crop growth and achieving the continuous increase of crop yield.

### SUMMARY

The present invention establishes preparation and application methods for a carbosilane based polymer soil conditioner capable of enhancing stress resistance of crops. The method prepares carbon and silicon-based natural polymer materials by preprocessing with straw waste, urea, persulfate, etc., and prepares a soil conditioner with functions of water retention and salt absorption through a series of prepolymerization reactions. The soil conditioner is simple in the synthetic process and low in cost, and can be used for improving saline alkali soil in large area, improving the capacity for the water and fertilizer retention of soil and enhancing the stress resistance of crops, thereby increasing the crop yield.

The technical solution of the present invention is as follows:

The preparation method for the carbosilane based polymer soil conditioner capable of enhancing stress resistance of crops comprises the following steps:
(1) taking 20-30 mass parts of straws crushed into powder, 1-5 mass parts of methyl-silicone oil as branched monomers, 1-2 mass parts of urea as an activator, and 10-20 parts of N, N-dimethylformamide as a reaction solution; mixing thoroughly; standing under room temperature conditions for 5-8 h to make the methyl-silicone oil fully permeate into the cellulose hydroxyl surface of the straw powder; obtaining a natural reticular branched macromolecular complex containing the silicone oil through a hydrogen bond protection effect formed by urea amino and the branched monomers; then, successively adding 1-2 mass parts of potassium hydroxide for adjusting the pH of the reaction solution, 5-10 mass parts of potassium thiosulfate as a reducing agent, and 1-2 mass parts of ammonium persulfate as an initiator and an oxidant; stirring thoroughly; conducting grafting and polymerization reactions under the conditions of 30-50° C. for 10-15 h; and after standing, conducting solid-liquid separation to obtain carbon and silicon-based natural polymer material a with functions of water retention and salt absorption;
(2) taking 20 mass parts of calcium lignosulphonate, 1-5 mass parts of urea as crosslinking agents, 5-10 mass parts of ferrous sulfate cation exchangers, and 50-100 mass parts of distilled water in a reactor; stirring to fully react under the conditions of 50-80° C. for 20-30 h to fully exchange calcium lignosulphonate and ferrous sulfate cations to form lignin ferric salt; meanwhile, forming hydrogen bonding by the urea amino with benzene-containing hydroxyl on lignin, thereby prepolymerizing to obtain a complex of iron lignin and calcium lignosulphonate with large molecular chains; then, successively adding 1-10 mass parts of polyacrylamide monomers, 1-5 mass parts of ammonium persulfate as an initiator, 10-50 parts of bentonite as a pore-forming agent, and 5-10 mass parts of polyvinyl alcohol as crosslinking agents; stirring constantly to completely dissolve the materials; under the conditions of 30-80° C., standing for conducting a polymerization reaction for 10-24 h; forming hydrogen bonds by hydroxyl on the complex of iron lignin and calcium lignosulphonate with amino on the polyacrylamide monomers; and meanwhile, under the action of the initiator and the crosslinking agents, forming macromolecular chains to obtain a viscous mixed solution b with the function of water retention;
(3) under room temperature conditions, thoroughly stirring and mixing 20 mass parts of the carbon and silicon-based natural polymer material a and 20 mass parts of the viscous mixed solution b prepared above; successively adding 1-2 mass parts of manganese sulfate and 1-5 mass parts of zinc sulfate and stirring thoroughly; adding distilled water to make the above liquid exactly reach 1000 mass parts; conducting an oscillatory reaction under the room temperature conditions for 15-48 h; standing for 10-15 h; and conducting solid-liquid separation and natural drying to obtain the carbosilane based polymer soil conditioner which has the functions of salt absorption and water retention and is capable of enhancing stress resistance of crops.

An application of the carbosilane based polymer soil conditioner obtained above is provided. The soil conditioner needs to be applied according to farmland and soil conditions and crop categories. The prepared soil conditioner can be used under conditions of flushing/application or drip irrigation. Specific use modes are as follows.

Saline alkali soil: the application rate is 10-100 L/mu, and the mode is fertigation or one-time drip irrigation with water, or determined based on the crop categories and irrigation frequency. The application rate in slightly saline alkali soil is 10-40 L/mu; the application rate in moderate saline alkali soil is 20-80 L/mu; and the application rate in severe saline alkali soil is 40-100 L/mu.

Farmland with low or moderate yield: the application rate is 10-100 L/mu, and the mode is fertigation or one-time drip irrigation with water, or determined based on the crop categories and irrigation frequency. When the yield is lower than the yield of local crops by more than 70%, the application rate is 10-100 L/mu; and when the yield is lower than the yield of local crops by more than 50%, the application rate is 40-100 L/mu.

Desertification soil: the application rate is 30-100 L/mu, and the mode is fertigation or one-time drip irrigation with water, or determined based on the crop categories and irrigation frequency. When the soil layers of 0-60 cm and below are desertified, the application rate is 60-100 L/mu; when the soil layers of 0-40 cm are desertified, the application rate is 40-100 L/mu; and when the soil layers of 0-20 cm are desertified, the application rate is 30-100 L/mu.

The straw waste comprises crop straws of cotton, corn, wheat and rice.

Use methods of the soil conditioner comprise application into the soil with water before sowing, successive application with water and fertilizer during the growth period of the crops, and one-time application with water during the growth season of the crops.

The application rate per mu of the soil conditioner, when applied in land for growing field crops, is 10-100 L, and diluted by 500-1000 times.

The present invention has the following beneficial effects: the present invention uses cheap and readily available straw waste, adds various reactants such as methyl-silicone oil, urea, potassium persulfate, potassium thiosulfate, etc., breaks the compact structure of the straws under mild conditions, and obtains carbon and silicon-based natural polymer materials with functions of water retention and salt absorption through prepolymerization reactions. The materials have loose and porous structure, which is conducive to enhance the adsorption capacity of the materials. Through a series of polymerization reactions of the carbon and silicon-based natural polymer materials with calcium lignosulphonate, polyacrylamide, etc., beneficial metal elements Zn and Mn needed for crop growth are added to enhance the stress resistance of the crops; and the soil conditioner capable of enhancing the stress resistance of the crops is prepared. The soil conditioner is simple in the synthetic process and low in cost, has main synthetic components that can be used as nutrients required for crop growth, and can be used for improving saline alkali soil in large area, improving the capacity for the water and fertilizer retention of the soil and enhancing the stress resistance of the crops, thereby increasing the crop yield.

### DESCRIPTION OF DRAWINGS

FIG. 1 shows effects of salt absorption and water retention of a soil conditioner.

FIG. 2 shows the improvement effect of a soil conditioner on saline alkali sandy soil.

### DETAILED DESCRIPTION

Specific embodiments of the present invention are further described below in combination with the drawings and the technical solution.

### Embodiment 1 Preparation and Performance Evaluation of Soil Conditioner

50.0 g of crushed straw waste, 2.5 g of methyl-silicone oil and 3.0 g of urea were weighed respectively, added to 50 mL of N, N-dimethylformamide solution, mixed thoroughly, and stood under room temperature conditions for 5 h to make the methyl-silicone oil fully permeate into the cellulose hydroxyl surface of the straw powder; then 2.5 g of potassium hydroxide was added; the pH of the reaction solution was adjusted; 15.0 g of potassium thiosulfate and 4.0 g of ammonium persulfate were added and stirred thoroughly to react under the conditions of 40° C. for 10 h; after the reaction was ended, the solution was stood and subjected to solid-liquid separation to obtain carbon and silicon-based natural polymer material al; and this step was repeated for three times to obtain 3 parts of identical carbon and silicon-based natural polymer material al.

Three parts of 20.0 g of calcium lignosulphonate, 2.0 g of urea and 5.0 g of ferrous sulfate were weighed successively, added to a reactor containing 50 mL of distilled water respectively and stirred thoroughly to fully react under the conditions of 50° C. for 20 h. Then, 1.0 g, 2.0 g and 5.0 g of polyacrylamide monomers, 1.0 g of ammonium persulfate, 20.0 g of bentonite and 10.0 g of polyvinyl alcohol were added successively, stirred constantly to completely dissolve the materials, and conducted a polymerization reaction under the conditions of 40° C. for 15 h to obtain viscous mixed solutions b1, b2 and b3 with the function of water retention.

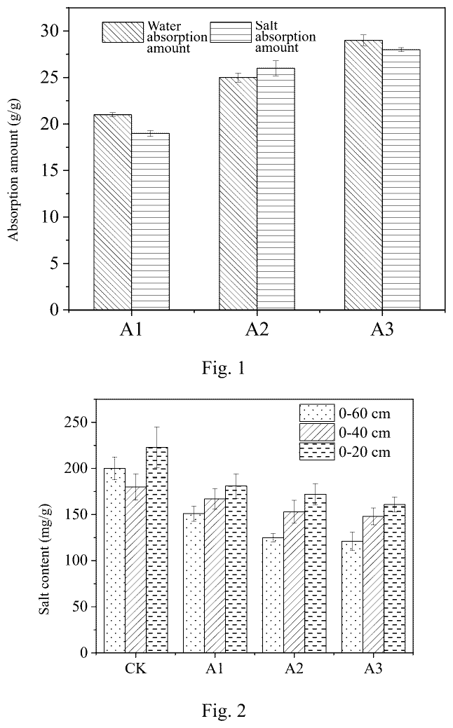

Under room temperature conditions, 3 parts of the carbon and silicon-based natural polymer material al were thoroughly stirred and mixed with the viscous mixed solutions b1, b2 and b3 respectively; 1.0 g of manganese sulfate and 2.0 g of zinc sulfate were successively added and stirred thoroughly; distilled water was added to make the above liquid exactly reach 1000 mass parts; an oscillatory reaction was conducted under the room temperature conditions for 15 h; the solution was stood for 10 h, subjected to solid-liquid separation and naturally dried for 2 d to obtain carbosilane based polymer soil conditioners A1, A2 and A3 which have the functions of salt absorption and water retention and are capable of enhancing stress resistance of crops. Salt and water absorption tests were used for analyzing the water and salt absorption capacities of the soil conditioner. As shown in FIG. 1, as the use amount of the polyacrylamide monomers is increased from 1.0 g to 5.0 g, the water absorption amount and the salt absorption amount of the prepared soil conditioner are increased by 38.1% and 47.4% respectively. This indicates that the increase in the use amount of the polyacrylamide monomers is conducive to enhance the water absorption capacity and the salt absorption capacity of the soil conditioner.

Embodiment 2 Preparation of Carbon and Silicon-based Natural Polymer Material with Good Water Absorption Capacity

50.0 g of crushed straw waste, 5.0 g of methyl-silicone oil and 4.0 g of urea were weighed respectively, added to 50 ml of N, N-dimethylformamide solution, mixed thoroughly, and stood under room temperature conditions for 5 h to make the methyl-silicone oil fully permeate into the cellulose hydroxyl surface of the straw powder; then 2.5 g of potassium hydroxide was added; the pH of the reaction solution was adjusted; 20.0 g of potassium thiosulfate and 4.0 g of ammonium persulfate were added and stirred thoroughly to react under the conditions of 30° C., 40° C. and 50° C. for 15 h respectively; and after the reaction was ended, the solution was stood and subjected to solid-liquid separation to obtain carbon and silicon-based natural polymer materials prepared under different temperature conditions.

To compare the water absorption capacities of the materials, carbon-containing biomass materials were prepared without adding methyl-silicone oil and urea according to the above conditions and processes. 50.0 g of crushed straw waste was weighed, added to 50 ml of N,N-dimethylformamide solution, and mixed thoroughly; then, 2.5 g of potassium hydroxide was added; the pH of the reaction solution was adjusted; 20.0 g of potassium thiosulfate and 4.0 g of ammonium persulfate were added and stirred thoroughly to react under the conditions of 30° C., 40° C. and 50° C. for 15 h respectively; and after the reaction was ended, the solution was stood and subjected to solid-liquid separation to prepare the carbon-containing biomass materials without adding methyl-silicone oil and urea. The water absorption test was used for comparing the water absorption performance of the materials prepared under different conditions. The results show that under three reaction temperature conditions of 30° C., 40° C. and 50° C., compared with the carbon-containing biomass materials prepared without adding methyl-silicone oil and urea, the water absorption amount of carbon and silicon-based biomass material prepared under the condition of adding methyl-silicone oil and urea is increased by 6.1%-13.7%. Meanwhile, with the increase of the reaction temperature, the water absorption amount of the prepared carbon and silicon-based biomass material is increased, which further indicates that the reaction temperature makes positive contributions to the water absorption capacity of the material.

### Embodiment 3 Preparation of Lignin-based Polymer Material with Good Salt Absorption Capacity

Three parts of 20.0 g of calcium lignosulphonate, 3.0 g of urea and 6.0 g of ferrous sulfate were weighed successively, added to a reactor containing 50 mL of distilled water respectively and stirred thoroughly to fully react at 50° C., 60° C., 70° C. and 80° C. for 30 h respectively. Then, 5.0 g of polyacrylamide monomers, 2.0 g of ammonium persulfate, 20.0 g of bentonite and 10.0 g of polyvinyl alcohol were added successively, stirred constantly to completely dissolve the materials, and conducted a polymerization reaction under the conditions of 40° C. for 15 h to obtain viscous mixed solutions with the function of water retention prepared under different temperature conditions.

To compare the effects of urea and ferrous sulfate, a control test was set. 20.0 g of calcium lignosulphonate was weighed, added to a reactor containing 50 mL of distilled water and stirred thoroughly to fully react at 50° C., 60° C., 70° C. and 80° C. for 30 h respectively. Then, 5.0 g of polyacrylamide monomers, 2.0 g of ammonium persulfate, 20.0 g of bentonite and 10.0 g of polyvinyl alcohol were added successively, stirred constantly to completely dissolve the materials, and conducted a polymerization reaction under the conditions of 40° C. for 15 h to obtain viscous mixed solutions prepared without adding urea and ferrous sulfate. The salt absorption performance of the materials prepared under different conditions was compared through the salt absorption test. The results show that under four reaction temperature conditions of 50° C., 60° C., 70° C. and 80° C., compared with the viscous mixed solutions prepared without adding urea and ferrous sulfate, the salt absorption amount of the viscous mixed solution prepared under the condition of adding urea and ferrous sulfate is increased by 4.8%-15.2%. Meanwhile, with the increase of the reaction temperature, the salt absorption amount of the prepared carbon and silicon-based biomass material is increased, which further indicates that more complex products will be produced with the increase of the reaction temperature.

### Embodiment 4 Evaluation of Improvement Effect of Soil Conditioner on Saline Alkali Soil

The test was conducted on sandy soil. The soil conditioners A1, A2 and A3 prepared in embodiment 1 were applied according to different soil types. After water was added to the materials, the soil conditioners were applied in a mode of one-time drip irrigation with water.

When the soil layers of 0-60 cm and below are desertified, the application rate is 60 L/mu; when the soil layers of 0-40 cm are desertified, the application rate is 40 L/mu; and when the soil layers of 0-20 cm are desertified, the application rate is 30 L/mu. Surface layer samples of soil were regularly collected to test salt content in the soil, and control processing was conducted at the same time. The results are shown in FIG. 2. With the increase of the use amount of the polyacrylamide monomers in the soil conditioners, the salt content in the soil layers of different sandy soil is gradually decreased by the maximum degrees of 65.3% (0-60 cm), 21.6% (0-40 cm) and 38.5% (0-20 cm) respectively, which also indicates that the soil conditioners have better salt control effects on deep salt.

1. A preparation method for a carbosilane based polymer soil conditioner capable of enhancing stress resistance of crops, comprising the following steps:
(1) taking 20-30 mass parts of straws crushed into powder, 1-5 mass parts of methyl-silicone oil as branched monomers, 1-2 mass parts of urea as an activator, and 10-20 parts of N,N-dimethylformamide as a reaction solution; mixing thoroughly; standing under room temperature conditions for 5-8 h to make the methyl-silicone oil fully permeate into the cellulose hydroxyl surface of the straw powder; obtaining a natural reticular branched macromolecular complex containing the silicone oil through a hydrogen bond protection effect formed by urea amino and the branched monomers; then, successively adding 1-2 mass parts of potassium hydroxide for adjusting the pH of the reaction solution, 5-10 mass parts of potassium thiosulfate as a reducing agent, and 1-2 mass parts of ammonium persulfate as an initiator and an oxidant; stirring thoroughly; conducting grafting and polymerization reactions under the conditions of 30-50° C. for 10-15 h; and after standing, conducting solid-liquid separation to obtain carbon and silicon-based natural polymer material a with functions of water retention and salt absorption;
(2) taking 20 mass parts of calcium lignosulphonate, 1-5 mass parts of urea as crosslinking agents, 5-10 mass parts of ferrous sulfate cation exchangers, and 50-100 mass parts of distilled water in a reactor; stirring to fully react under the conditions of 50-80° C. for 20-30 h to fully exchange calcium lignosulphonate and ferrous sulfate cations to form lignin ferric salt; meanwhile, forming hydrogen bonding by the urea amino with benzene-containing hydroxyl on lignin, thereby prepolymerizing to obtain a complex of iron lignin and calcium lignosulphonate with large molecular chains; then, successively adding 1-10 mass parts of polyacrylamide monomers, 1-5 mass parts of ammonium persulfate as an initiator, 10-50 parts of bentonite as a pore-forming agent, and 5-10 mass parts of polyvinyl alcohol as crosslinking agents; stirring constantly to completely dissolve the materials; under the conditions of 30-80° C., standing for conducting a polymerization reaction for 10-24 h; forming hydrogen bonds by hydroxyl on the complex of iron lignin and calcium lignosulphonate with amino on the polyacrylamide monomers; and meanwhile, under the action of the initiator and the crosslinking agents, forming macromolecular chains to obtain a viscous mixed solution b with the function of water retention;
(3) under room temperature conditions, thoroughly stirring and mixing 20 mass parts of the carbon and silicon-based natural polymer material a and 20 mass parts of the viscous mixed solution b prepared above; successively adding 1-2 mass parts of manganese sulfate and 1-5 mass parts of zinc sulfate and stirring thoroughly; adding distilled water to make the above liquid exactly reach 1000 mass parts; conducting an oscillatory reaction under the room temperature conditions for 15-48 h; standing for 10-15 h; and conducting solid-liquid separation and natural drying to obtain the carbosilane based polymer soil conditioner which has the functions of salt absorption and water retention and is capable of enhancing stress resistance of crops.

2. The preparation method for the carbosilane based polymer soil conditioner according to claim 1, wherein straw waste comprises straws of cotton, corn, wheat and rice.

3. An application of a carbosilane based polymer soil conditioner obtained by the preparation method for the carbosilane based polymer soil conditioner according to claim 1, wherein the carbosilane based polymer soil conditioner needs to be applied according to farmland and soil conditions and crop categories; and specific use modes are as follows:
saline alkali soil: the application rate of the carbosilane based polymer soil conditioner in slightly saline alkali soil is 10-40 L/mu; the application rate of the carbosilane based polymer soil conditioner in moderate saline alkali soil is 20-80 L/mu; the application rate of the carbosilane based polymer soil conditioner in severe saline alkali soil is 40-100 L/mu; and the mode is fertigation or one-time drip irrigation with water, or determined based on the crop categories and irrigation frequency;
farmland with low or moderate yield: when the yield is lower than the yield of local crops by more than 70%, the application rate of the carbosilane based polymer soil conditioner is 10-100 L/mu; when the yield is lower than the yield of local crops by more than 50%, the application rate of the carbosilane based polymer soil conditioner is 40-100 L/mu; and the mode is fertigation or one-time drip irrigation with water, or determined based on the crop categories and irrigation frequency;
desertification soil: when the soil layers of 0-60 cm and below are desertified, the application rate of the carbosilane based polymer soil conditioner is 60-100 L/mu; when the soil layers of 0-40 cm are desertified, the application rate of the carbosilane based polymer soil conditioner is 40-100 L/mu; and when the soil layers of 0-20 cm are desertified, the application rate of the carbosilane based polymer soil conditioner is 30-100 L/mu; and the mode is fertigation or one-time drip irrigation with water, or determined based on the crop categories and irrigation frequency.

4. The application according to claim 3, wherein use methods of the carbosilane based polymer soil conditioner comprise application into the soil with water before sowing, successive application with water and fertilizer during the growth period of the crops, and one-time application with water during the growth season of the crops.

5. The application according to claim 3, wherein the application rate per mu of the soil conditioner, when applied in land for growing field crops, is 10-100 L, and diluted by 500-1000 times.
